(19) United States
(12) Patent Application Publication
(10) Pub. No.: US 2009/0117532 A1
(43) Pub. Date: May 7, 2009

(54) Pre-clinical method for monitoring serial changes in circulating breast cancer cells in mice

(76) Inventor: Gerald V. DOYLE, Radnor, PA (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 12/254,151

(22) Filed: Oct. 20, 2008

Related U.S. Application Data
(60) Provisional application No. 61/001,418, filed on Nov. 1, 2007.

(51) Int. Cl. A01N 1/02

(52) U.S. Cl. 435/2

(57) ABSTRACT

The CellTracks® System provides a system to enumerate CTC's in blood. The system immunomagnetically concentrates epithelial cells, fluorescently labels the cells and identifies and quantifies CTC's. The absolute number of CTC's detected in the peripheral blood tumor load is, in part, a factor in prediction of survival, time to progression, and response to therapy. Pre-clinical studies of circulating tumor cells (CTC's) have been limited by the inability to repetitively monitor CTC's in animal models. The present invention provides a method to enumerate CTC's in blood samples obtained from living mice, using a protocol similar to an in vitro diagnostic system for quantifying CTC's in patients. Accordingly, this technology can be adapted for serial monitoring of CTC's in mouse xenograft tumor models of human breast cancer.

### CROSS-REFERENCE TO RELATED APPLICATIONS

This is a non-provisional application which claims priority to U.S. Provisional Applications 61/001,418, filed Nov. 1, 2007. The aforementioned application is incorporated in full by reference herein.

### BACKGROUND

1. Field of the Invention

The invention relates generally to cancer monitoring and assessing disease progression in metastatic cancer patients, based on the presence of morphologically intact circulating cancer cells (CTC) in blood. More specifically, methods, reagents and apparatus are described for assessing circulating cancer cells in animal models.

2. Background Art

Non-hematogenous epithelial tumor cells were first identified in the blood of a breast cancer patient over 150 years ago. Since then, CTC's have been shown to be a critical link between primary cancer, a disease stage at which cure is possible, and metastatic disease, which continues to be the leading cause of death for most malignancies. Clinical studies have shown that CTC's are a powerful prognostic and predictive biomarker in metastatic breast cancer, and similar findings have been reported in prostate cancer and colorectal cancer. From this data, CTC's have been shown to be representative of the underlying biology driving metastatic cancer and suggest that further cellular and molecular analyses of these cells can reveal new insights into molecular regulation of metastasis and response to therapy.

Research on the role of CTC in metastasis and expansion of their use as a biomarker in pharmacokinetic and pharmacodynamic studies has been limited to the clinical phase of drug development. It is generally accepted that most cancer patients are not killed by their primary tumor, but they succumb instead to metastases: multiple widespread tumor colonies established by malignant cells that detach themselves from the original tumor and travel through the body, often to distant sites. The most successful therapeutic strategy in cancer is early detection and surgical removal of the tumor while still organ confined. Early detection of cancer has proven feasible for some cancers, particularly where appropriate diagnostic tests exist such as PAP smears in cervical cancer, mammography in breast cancer, and serum prostate specific antigen (PSA) in prostate cancer. However, many cancers detected at early stages have established micrometastases prior to surgical resection. Thus, early and accurate determination of the cancer's malignant potential is important for selection of proper therapy.

If a primary tumor is detected early enough, it can often be eliminated by surgery, radiation, or chemotherapy or some combination of those treatments. Unfortunately, the metastatic colonies are difficult to detect and eliminate and it is often impossible to treat all of them successfully. Therefore, metastasis can be considered the conclusive event in the natural progression of cancer. Moreover, the ability to metastasize is a property that uniquely characterizes a malignant tumor.

Based on the complexity of cancer and cancer metastasis and the frustration in treating cancer patients over the years, many attempts have been made to develop diagnostic tests to guide treatment and monitor the effects of such treatment on metastasis or relapse.

One of the first attempts to develop a useful test for diagnostic oncology was the formulation of an immunoassay for carcinoembryonic antigen (CEA). This antigen appears on fetal cells and reappears on tumor cells in certain cancers. Extensive efforts have been made to evaluate the usefulness of testing for CEA as well as many other “tumor” antigens, such as prostate specific antigen (PSA), CA 15.3, CA 125, prostate-specific membrane antigen (PSMA), CA 27.29, p27 found in either tissue samples or blood as soluble cellular debris.

Additional tests used to predict tumor progression in cancer patients have focused upon correlating enzymatic indices like telomerase activity in biopsy-harvested tumor samples with an indication of an unfavorable or favorable prognosis (U.S. Pat. No. 5,693,474; U.S. Pat. No. 5,639,613). Assessing enzyme activity in this type of analysis can involve time-consuming laboratory procedures such as gel electrophoresis and Western blot analysis. Also, there are variations in the signal to noise and sensitivity in sample analysis based on the origin of the tumor. Despite these shortcomings, specific soluble tumor markers in blood can provide a rapid and efficient approach for developing a therapeutic strategy early in treatment. For example, detection of serum HER-2/neu and serum CA 15-3 in patients with metastatic breast cancer have been shown to be prognostic factors for metastatic breast cancer (Ali S. M., Leitzel K., Chinchilli V. M., Engle L., Demers L., Harvey H. A., Carney W., Allard J. W. and Lipton A., Relationship of Serum HER-2/neu and Serum CA 15-3 in Patients with Metastatic Breast Cancer, Clinical Chemistry, 48(8):1314-1320 (2002)). Increased HER-2/neu results in decreased response to hormone therapy, and is a significant prognostic factor in predicting responses to hormone receptor-positive metastatic breast cancer. Thus in malignancies where the HER-2/neu oncogene product is associated, methods have been described to monitor therapy or assess risks based on elevated levels (U.S. Pat. No. 5,876,712). However in both cases, the base levels during remission, or even in healthy normals, are relatively high and may overlap with concentrations found in patients, thus requiring multiple testing and monitoring to establish patient-dependent baseline and cut-off levels.

In prostate cancer, PSA levels in serum have proven to be useful in early detection. When used with a follow-up physical examination and biopsy, the PSA test has improved detection of prostate cancer at an early stage when it is best treated.

However, PSA or the related PSMA testing leaves much to be desired. For example, elevated levels of PSA weakly correlate with disease stage and appear not to be a reliable indicator of the metastatic potential of the tumor. This may be due in part to the fact that PSA is a component of normal prostate tissue and benign prostatic hyperplasia (BHP) tissue. Moreover, approximately 30% of patients with alleged localized prostate cancer and corresponding low serum PSA concentrations, may have metastatic disease (Moreno et al., Cancer Research, 52:6110 (1992)).

### Genetic Markers:

One approach for determining the presence of malignant prostate tumor cells has been to test for the expression of messenger RNA from PSA in blood. This is being done through the laborious procedure of isolating all of the mRNA from the blood sample and performing reverse transcriptase PCR. No significant correlation has been described between the presence of shed tumor cells in blood and the ability to identify which patients would benefit from more vigorous treatment (Gomella L G., J of Urology, 158:326-337 (1997)). Additionally, false positives are often observed using this technique. There is an added drawback, which is that there is a finite and practical limit to the sensitivity of this technique based on the sample size. Typically, the test is performed on 10⁵ to 10⁶ cells separated from interfering red blood cells, corresponding to a practical lower limit of sensitivity of one tumor cell/0.1 ml of blood (about 10 tumor cells in one ml of blood) before a signal is detected. Higher sensitivity has been suggested by detecting hK2 RNA in tumor cells isolated from blood (U.S. Pat. No. 6,479,263; U.S. Pat. No. 6,235,486).

Qualitative RT-PCR based studies with blood-based nucleotide markers has been used to indicate that the potential for disease-free survival for patients with positive CEA mRNA in pre-operative blood is worse than that of patients negative for CEA mRNA (Hardingham J. E., Hewett P. J., Sage R. E., Finch J. L., Nuttal J. D., Kotasel D. and Dovrovic A., Molecular detection of blood-borne epithelial cells in colorectal cancer patients and in patients with benign bowel disease, Int. J. Cancer 89:8-13 (2000): Taniguchi T., Makino M., Suzuki K., Kaibara N., Prognostic significance of reverse transcriptase-polymerase chain reaction measurement of carcinoembryonic antigen mRNA levels in tumor drainage blood and peripheral blood of patients with colorectal carcinoma, Cancer 89:970-976 (2000)). The prognostic value of this endpoint is dependent upon CEA mRNA levels, which are also induced in healthy individuals by G-CSF, cytokines, steroids, or environmental factors. Hence, the CEA mRNA marker lacks specificity and is clearly not unique to circulating colorectal cancer cells.

The aforementioned studies, while seemingly prognostic under the experimental conditions, do not provide for consistent data with a long follow-up period or at a satisfactory specificity. Accordingly, these efforts have proven to be somewhat futile as the appearance of mRNA for antigens in blood have not been generally predictive for most cancers and are often detected when there is little hope for the patient.

In spite of this, real-time reverse transcriptase-polymerase chain reaction (RT-PCR) has been the only procedure reported to correlate the quantitative detection of circulating tumor cells with patient prognosis. Real-time RT-PCR has been used for quantifying CEA mRNA in peripheral blood of colorectal cancer patients (Ito S., Nakanishi H., Hirai T., Kato T., Kodera Y., Feng Z., Kasai Y., Ito K., Akiyama S., Nakao A., and Tatematsu M., Quantitative detection of CEA expressing free tumor cells in the peripheral blood of colorectal cancer patients during surgery with real-time RT-PCR on a Light Cycler, Cancer Letters, 183:195-203 (2002)). These results suggest that tumor cells were shed into the bloodstream (possibly during surgical procedures or from micro metastases already existing at the time of the operation), and resulted in poor patient outcomes in patients with colorectal cancer. The sensitivity of this assay provided a reproducibly detectable range similar in sensitivity to conventional RT-PCR. As mentioned, these detection ranges are based on unreliable conversions of amplified product to the number of tumor cells. The extrapolated cell count may include damaged CTC incapable of metastatic proliferation. Further, PCR-based assays are limited by possible sample contamination, along with an inability to quantify tumor cells. Most importantly, methods based on PCR, flowcytometry, cytoplasmic enzymes and circulating tumor antigens cannot provide essential morphological information confirming the structural integrity underlying metastatic potential of the presumed CTC and thus constitute functionally less reliable surrogate assays than the highly sensitive imaging methods embodied, in part, in this invention.

Detection of intact tumor cells in blood provides a direct link to recurrent metastatic disease in cancer patients who have undergone resection of their primary tumor. Unfortunately, the same spreading of malignant cells continues to be missed by conventional tumor staging procedures. Recent studies have shown that the presence of a single carcinoma cell in the bone marrow of cancer patients is an independent prognostic factor for metastatic relapse (Diel I J, Kaufman M, Goerner R, Costa S D, Kaul S, Bastert G. Detection of tumor cells in bone marrow of patients with primary breast cancer: a prognostic factor for distant metastasis. J Clin Oncol, 10:1534-1539, 1992). But these invasive techniques are deemed undesirable or unacceptable for routine or multiple clinical assays compared to detection of disseminated epithelial tumor cells in blood.

An alternative approach incorporates immunomagnetic separation technology and provides greater sensitivity and specificity in the unequivocal detection of intact circulating cancer cells. This simple and sensitive diagnostic tool, as described (U.S. Pat. No. 6,365,362; U.S. Pat. No. 6,551,843; U.S. Pat. No. 6,623,982; U.S. Pat. No. 6,620,627; U.S. Pat. No. 6,645,731; WO 02/077604; WO03/065042; and WO 03/019141) is used in the present invention to provide a preclinical animal model to enumerate CTC's.

The assay depends upon the acquisition of a preserved blood sample from a patient. The blood sample from a cancer patient (WO 03/018757) is incubated with magnetic beads, coated with antibodies directed against an epithelial cell surface antigen as for example EpCAM. After labeling with anti-EpCAM-coated magnetic nanoparticles, the magnetically labeled cells are then isolated using a magnetic separator. The immunomagnetically enriched fraction is further processed for downstream immunocytochemical analysis or image cytometry, for example, in the CellTracks® System (Veridex LLC, NJ). The magnetic fraction can also be used for downstream immunocytochemical analysis, RT-PCR, PCR, FISH, flowcytometry, or other types of image cytometry.

The CellTracks® System utilizes immunomagnetic selection and separation to highly enrich and concentrate any epithelial cells present in whole blood samples. The captured cells are detectably labeled with a leukocyte specific marker and with one or more tumor cell specific fluorescent monoclonal antibodies to allow identification and enumeration of the captured CTC's as well as unequivocal instrumental or visual differentiation from contaminating non-target cells. This assay allows tumor cell detection even in the early stages of low tumor mass. The embodiment of the present invention is not limited to the CellTracks® System, but includes any isolation and imaging protocol of comparable sensitivity and specificity.

Currently available preclinical protocols have not demonstrated a consistently reliable means for repetitively monitoring CTC's in assessing metastatic breast cancer (MBC) progression. The development of a reliable mouse model to assess diagnostic and therapeutic advancements in cancer research would provide a means to further research development in these areas. Thus, there is a clear need for accurate detection of cancer cells with metastatic potential, not only in MBC but in metastatic cancers in general. Moreover, this need is accentuated by the need to select the most effective therapy for a given patient.

The inability to repetitively monitor CTC's in the small blood volumes available in pre-clinical animal models of breast and other cancers has restricted their use to analysis of samples obtained from terminal blood draws. As a consequence, the study of temporal changes in CTC's during tumor progression and therapy in a living animal model, such as in mice, as not been established. However, using this technology to serially assay CTC's in mice would permit integration of CTC's assessments into pre-clinical as well as clinical studies. Further characterization of specific molecular markers on these cells would permit early development of “companion” diagnostic assays for targeted therapies, which would accelerate translation of new assay protocols into clinical trials in patients and ultimately into clinical practice.

### SUMMARY OF THE INVENTION

The present invention provides a method and means for preclinical modeling of cancer metastasis in xenograft mice, incorporating clinical analysis tools such as the CellTracks® System, and is based upon the absolute number, change, or combinations of both of circulating epithelial cells in patients with metastatic cancer. The system immunomagnetically concentrates epithelial cells, fluorescently labels the cells, identifies and quantifies CTC's for positive enumeration in zenograft tumor models of human breast cancer.

### BRIEF DESCRIPTION OF THE DRAWINGS

FIG. 1: CellTracks® fluorescent analysis profile used to confirm objects captured as human tumor cells. Check marks signify a positive tumor cell based on the composite image. Composite images are derived from the positive selection for Epithelial Cell Marker (EC-PE) and for the nuclear dye (NADYE). A negative selection is also needed for the leukocyte marker (L-APC) and for control (CNTL).

FIG. 2: Quantification of human breast cancer cells in mouse blood samples. MDA-MB-231 human breast cancer cells without or with stable transduction of GFP were added to 100 μl blood samples from mice without tumor xenografts. Samples were fixed, and epithelial cells were enriched by immunomagnetic bead isolation using an antibody to epithelial cell adhesion molecule. Recovered cells then were stained with an antibody to cytokeratin (8, 18, and 19) to identify epithelial cells and distinguish them from leukocytes stained with CD45. Nucleated cells were identified by staining with the fluorescent nucleic acid dye 4,2-diamidino-2-phenylindole dihydrochloride (DAPI). GFP on cancer cells was detected in the FITC channel. Representative images of recovered breast cancer cells are shown.

FIG. 3: Quantification of human breast cancer cells in mouse blood samples. Terminal blood samples from mice bearing xenografts of MDA-MB-231 human breast cancer cells were obtained by cardiac puncture and analyzed for CTC. Numbers of CTC are plotted versus tumor volumes measured by calipers.

FIG. 4: Serial analysis of CTC in mice. Mice were implanted with orthotopic tumor xenografts of SUM-159 (A) or SKBR-3 (B) human breast cancer cells, and CTC in approximately 100 μl blood samples were measured by cardiac puncture at approximately weekly intervals until mice were euthanized because of tumor burden. CTC data were normalized to 100 μl volume and plotted against tumor volume for individual. Mean numbers of CTC were significantly greater on day 30 as compared with prior days (p<0.05).

### DETAILED DESCRIPTION OF THE INVENTION

While any effective mechanism for isolating, enriching, and analyzing CTC's in blood is appropriate, one method for collecting circulating tumor cells combines immunomagnetic enrichment technology, immunofluorescent labeling technology with an appropriate analytical platform after initial blood draw. The associated test has been shown to have the sensitivity and specificity to detect these rare cells in a sample of whole blood and to investigate their role in the clinical course of the disease in malignant tumors of epithelial origin. From a sample of whole blood, rare cells are detected with a sensitivity and specificity to allow them to be collected and used in modeling disease progression in an animal model.

Circulating tumor cells (CTC's) have been shown to exist in the blood in detectable amounts. This created a tool to investigate the significance of cells of epithelial origin in the peripheral circulation of cancer patients (Racila E., Euhus D., Weiss A. J., Rao C., McConnell J., Terstappen L. W. M. M. and Uhr J. W., Detection and characterization of carcinoma cells in the blood, Proc. Natl. Acad. Sci. USA, 95:4589-4594 (1998)). This study demonstrated that these blood-borne cells might have a significant role in the pathophysiology of cancer. Having a detection sensitivity of 1 epithelial cell per 5 ml of patient blood, the assay incorporated immunomagnetic sample enrichment and fluorescent monoclonal antibody staining followed by flowcytometry for a rapid and sensitive analysis of a sample.

The CellSearch™ System (Veridex LLC, NJ) previously has been used to isolate and enumerate circulating epithelial tumor cells from human blood samples². This is an automated system that enriches for epithelial cells using antibodies to epithelial-cell adhesion molecule coupled to magnetic beads. Isolated cells then are stained with the fluorescent nucleic acid dye 4,2-diamidino-2-phenylindole dihydrochloride (DAPI) to identify nucleated cells. Recovered cells subsequently are stained with fluorescently labeled monoclonal antibodies to CD45 (APC channel) and cytokeratin 8, 18, 19 (PE channel) to distinguish epithelial cells from leukocytes. Nucleated epithelial cells then are quantified as circulating tumor cells. There is an additional fluorescence channel for FITC that is not part of the standard CellSearch™ assay and may be used for further characterization of tumor cells.

As shown in Example 1, the assay was further configured to an image cytometric analysis such that the immunomagnetically enriched sample is analyzed by the CellTracks® System. This is a fluorescence-based microscope image analysis system, which in contrast with flowcytometric analysis permits the visualization of events and the assessment of morphologic features to further identify objects.

### EXAMPLE 1

### Enumeration of Circulating Cytokeratin Positive Cells

The CellTracks® System refers to an automated fluorescence microscopic system for automated enumeration of isolated cells from blood. The system contains an integrated computer controlled fluorescence microscope and automated stage with a magnetic yoke assembly that will hold a disposable sample cartridge. The magnetic yoke is designed to enable ferrofluid-labeled candidate tumor cells within the sample chamber to be magnetically localized to the upper viewing surface of the sample cartridge for microscopic viewing. Software presents suspect cancer cells, labeled with antibodies to cytokeratin and having epithelial origin, to the operator for final selection.

While isolation of tumor cells for the CellTracks® System can be accomplished by any means known in the art, one embodiment uses immunomagentic enrichment for isolating tumor cells from a biological sample. Epithelial cell-specific magnetic particles are added and incubated for 20 minutes. After magnetic separation, the cells bound to the immunomagnetic-linked antibodies are magnetically held at the wall of the tube. Unbound sample is then aspirated and an isotonic solution is added to resuspend the sample. A nucleic acid dye, monoclonal antibodies to cytokeratin (a marker of epithelial cells) and CD 45 (a broad-spectrum leukocyte marker) are incubated with the sample. After magnetic separation, the unbound fraction is again aspirated and the bound and labeled cells are resuspended in 0.2 ml of an isotonic solution. The sample is suspended in a cell presentation chamber and placed in a magnetic device whose field orients the magnetically labeled cells for fluorescence microscopic examination in the CellTracks® System. Cells are identified automatically in the CellTracks® System and candidate circulating tumor cells presented to the operator for checklist enumeration. An enumeration checklist consists of predetermined morphologic criteria constituting a complete cell.

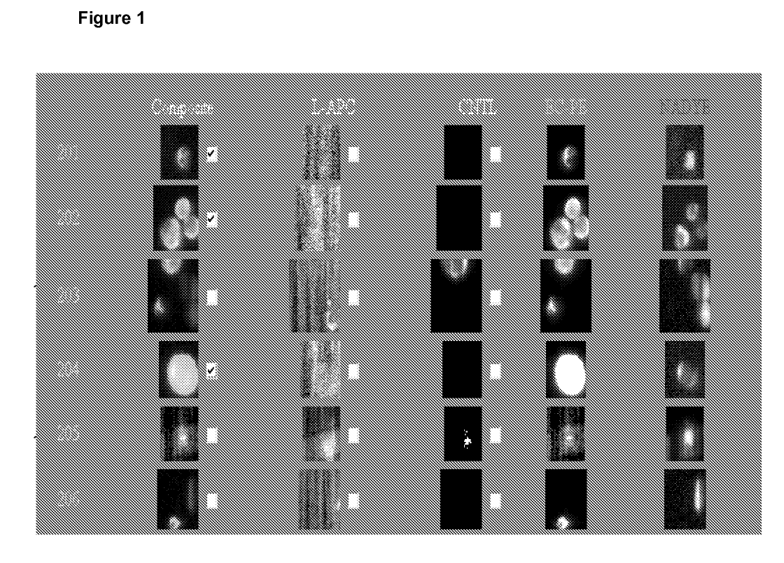

Cytokeratin positive cells are isolated by immunomagnetic enrichment using a 7.5 ml sample of whole blood from humans. Epithelial cell-specific immunomagnetic fluid is added and incubated for 20 minutes. After magnetic separation for 20 minutes, the cells bound to the immunomagnetic-linked antibodies are magnetically held at the wall of the tube. Unbound sample is then aspirated and an isotonic solution is added to resuspend the sample. A nucleic acid dye, monoclonal antibodies to cytokeratin (a marker of epithelial cells) and CD 45 (a broad-spectrum leukocyte marker) are incubated with the sample for 15 minutes. After magnetic separation, the unbound fraction is again aspirated and the bound and labeled cells are resuspended in 0.2 ml of an isotonic solution. The sample is suspended in a cell presentation chamber and placed in a magnetic device whose field orients the magnetically labeled cells for fluorescence microscopic examination in the CellTracks® System. Cells are identified automatically in the CellTracks® System; control cells are enumerated by the system, whereas the candidate circulating tumor cells are presented to the operator for enumeration using a checklist as shown in FIG. 1.

### EXAMPLE 2

### In Vitro Recovery of Human Epithelial Cells

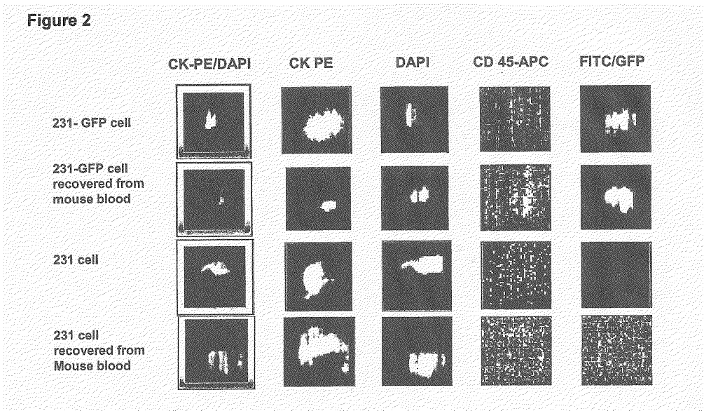

To accomplish this, 500 MDA-MB-231 breast cancer cells were spiked into 100 μl blood samples collected from mice without tumors. Since the clinical version of the assay requires blood be drawn into a proprietary vacuum tube, such as the CellSave tube, containing both an anticoagulant and a preservative, a proportionately reduced amount of CellSave solution was added to the specimens. The spiked specimens were then prepared, the CTC quantified and the percent recovery calculated. As a positive control, additional samples using MDA-MB-231 cells stably transduced with GFP were prepared. Fluorescence from GFP was detected in an open channel (FITC) of the system to confirm that all cells quantified as epithelial cells corresponded with 231-GFP cells added to mouse blood. As a negative control, mouse blood samples without cancer cells were collected, processed in an identical manner and analyzed. Of the 500 cells added to mouse blood (n=4 samples), 482-526 cells per specimen were recovered, which is within the range of the dilution error for spike-in experiments at this concentration (FIG. 2). For samples using 231-GFP cells, all cells identified as epithelial cells also expressed GFP, verifying that these were human breast cancer cells and not contaminating murine epithelial cells. No epithelial cells were recovered from normal mouse blood, confirming the specificity of the assay.

### EXAMPLE 3

### Recovery of CTC from Xenografts in Mice

The preferred method to serially monitor CTC's in mouse models of human breast cancer incorporates the use of the CellTracks® System. As previously discussed, the system uses immunomagnetic isolation of epithelial cells from blood and immunofluorescent staining to further differentiate epithelial cancer cells from leukocytes. Because the CellTracks® system was originally developed to process 7.5 to 30 ml human blood samples, it is necessary that human epithelial breast cancer cells could be reliably recovered from small volumes of mouse blood using this assay (see Example 2).

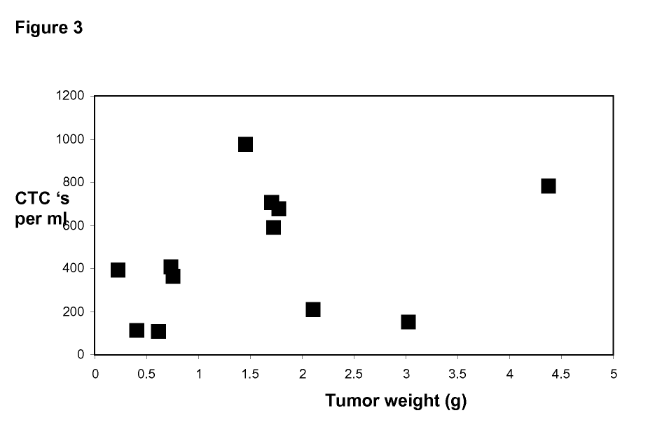

The system was used to identify CTC's that spontaneously intravasate into the circulation from orthotopic tumor xenografts of MDA-MB-231 cells. 0.7 to 1 ml blood samples were collected from each mouse by puncture of the left ventricle when animals were euthanized for tumor burden at 10 weeks. Total numbers of CTC's ranged from approximately 100 to 1000 cells per ml of blood (FIG. 3). No CTC's were recovered from blood samples collected from mice without tumor xenografts (data not shown). The number of CTC's did not correlate with size of the primary tumor. These data suggest that numbers of CTC's reflect the underlying biology of various primary tumors, which is consistent with previous studies showing that MDA-MB-231 cells contain subpopulations with differing metastatic potential. Using the same method, CTC's were also detectable in mice with tumor xenografts of MCF-7, MCF-7 cells stably transfected with fibroblast growth factor (FGF), SUM-159, and SKBR-3 cell-lines.

While the system was successful in detecting CTC's using cardiac puncture to collect blood, this procedure is invasive compared to other sites of blood sampling in mice. One aspect of the present invention is to repetitively draw blood samples for analysis of CTC's, blood samples from the lateral tail vein and retro-orbital venous plexus and thereby avoid the invasive nature of cardiac puncture. In mice with or without orthotopic MDA-MB-231 tumor xenografts were compared to direct cardiac sampling. No epithelial cells were detected in any of the lateral tail vein samples, independent of the presence of a tumor xenograft. One possible explanation for the failure to detect CTC's in tumor-bearing mice was the small volume of blood (≦25 μl) that could be collected from the lateral tail vein. Although larger volumes of blood (50-75 μl) could be obtained from the retro-orbital venous plexus, 3 of 3 blood samples from this site contained epithelial cells (5-500 cells) in mice without tumors. These contaminating cells were normal murine epithelial cells dislodged by the microcapillary tube during blood collection. Thus sampling via the retro-orbital route would make it impossible to reliably identify CTC in tumor-bearing mice. By comparison, there were no CTC's in blood samples obtained by cardiac puncture in mice without tumor xenografts, but CTC's could be detected in blood obtained via left ventricle cardiac puncture in mice with MDA-MB-231 xenografts.

### EXAMPLE 4

### Temporal Analysis of CTC's in Mice

After validating the assay and route of blood collection, the feasibility of detecting temporal changes in CTC's was investigated using mice implanted with orthotopic tumor xenografts of SUM-159 (n=3) or SKBR-3 (n=4) cells. 75 to 100 μl blood samples were collected approximately once per week for 1 month until mice were euthanized because of tumor burden. MDA-MB-231 and SKBR-3 human breast cancer cells were cultured in DMEM with 10% fetal bovine serum, 1% L-glutamine, and 0.1% penicillin/streptomycin. SUM-159 cells were cultured in Ham's F12 medium (Invitrogen) supplemented with 5% fetal bovine serum (FBS), 5 μg/ml insulin, 1 μg/ml hydrocortisone, and 0.1% penicillin/streptomycin. Cells were maintained at 37° C. in a 5% CO₂ incubator. For selected experiments, MDA-MB-231 cells were transduced with the lentiviral vector pSico to establish cells that stably express GFP. Efficiency of transduction was 100%, as determined by phase-contrast and fluorescence microscopy.

In producing tumor xenografts in mice, 5 to 6 week old female Ncr nude (Taconic) or SCID (Jackson) mice were used. Human breast tumor xenografts from cell lines, 1×10⁶ cells were injected orthotopically into bilateral inguinal mammary fat pads of mice by methods know in the art. For tumor xenografts with clinical isolates of human breast cancer cells, mice were implanted with 1-5×10⁵ cells in the fourth inguinal mammary fat pad. Mice implanted with clinical breast cancer isolates also received a subcutaneous pellet of 60-day sustained release 17-β-estradiol (Innovative Research of America). Volumes of tumors were quantified as the product of caliper measurements in two dimensions and calculated by the equation: width (mm)×width (mm)×length (mm)×0.52. For serial studies of CTC, blood samples were collected from the left ventricle at approximately weekly intervals as shown in the figure legend.

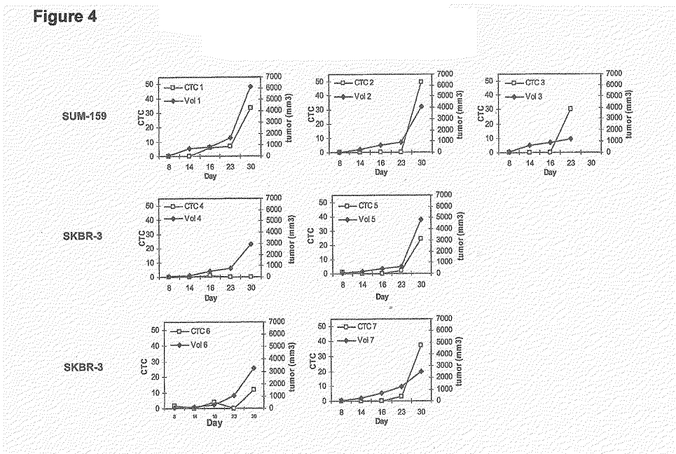

Assay results show low levels of CTC's (0-7 cells) in earlier samples (days 8-23) (FIG. 4), with numbers of CTC's increasing significantly on day 30 in 6 of 7 mice (26-55 cells) (p<0.05), corresponding to an increase in tumor volume. These studies establish that the assay can be used successfully for serial studies of CTC's in mouse models of breast cancer.

For all CTC's measured in mice implanted with xenografts, primary breast cancer cells were obtained from patient biopsy specimens. Blood samples (200 μL-800 μL) were collected via cardiac puncture at the time animals were euthanized because of tumor burden. Breast cancer cells from 6 different patients formed tumors in mice, and all of these tumors produced CTC's. Numbers of CTC's ranged from 4-805 cells per ml of blood with a mean value of 118 cells ±67 (n=6). Notably, none of these animals had overt or histologically detectable metastases (data not shown), suggesting that the majority of CTC's produced by primary clinical specimens may not be capable of forming metastases in either mice or in humans. These data show that xenografts of clinical breast cancer isolates can produce CTC's in mice and therefore provide a model system for investigating properties and subpopulations of human breast cancer cells involved in metastasis.

While certain of the preferred embodiments of the present invention have been described and specifically exemplified above, it is not intended that the invention be limited to such embodiments. Various modification may be made thereto without departing from the spirit of the present invention, the full scope of the improvements are delineated in the following claims.

What is claimed is:

1. A method for analysis of metastatic circulating rare cells in a preclinical tumor xenograft mouse model comprising:
a) obtaining a 100 μl blood sample from a xenograft mouse model, said sample comprising a mixed cell population suspected of containing said rare cells;
b) enriching a fraction of said specimen, said fraction containing said rare cells;
c) confirming structural integrity of said rare cells to be intact;
d) analyzing said intact rare cells; and
e) repeating steps a through d to assess disease progression.

2. A method as claimed in claim 1, wherein said xenograft mouse model is from a mouse that spontaneously intravates CTC's in the circulation from orthotopic tumor xenografts of MDA-MB-231 cells, SUM-159 cells, SKBR-3 cells and combinations thereof.

3. A method as claimed in claim 1, wherein said xenograft mouse model is made by implanting clinical breast cancer isolates in mice.

4. A method as claimed in claim 3, wherein said mice received a subcutaneous pellet of sustained release 17-β-estradiol.

5. A method as claimed in claim 1, wherein said blood sample is obtained by cardiac puncture.

6. A method as claimed in claim 1, wherein said fraction is obtained by immunomagnetic enrichment using an externally applied magnetic field to separate paramagnetic particles coupled to a biospecific ligand which specifically binds to said rare cells, to the substantial exclusion of other populations.

7. A method as claimed in claim 1, wherein said structural integrity is determined by a procedure selected from the group consisting of immunocytochemical procedures, FISH procedures, flowcytometry procedures, image cytometry procedures, and combinations thereof.

8. A method as claimed in claim 1, wherein an increase in the number of said intact rare cells present in said specimen corresponds to disease progression.

9. A method as claimed in claim 1, wherein said rare cells is from the group consisting of metastatic breast cancer cells, metastatic prostate cancer cells, bladder cancer cells, metastatic colon cancer cells, and combinations thereof.
